(19) United States
(12) Patent Application Publication
(10) Pub. No.: US 2024/0045384 A1
(43) Pub. Date: Feb. 8, 2024

(54) WATER QUALITY CONTROL SYSTEMS AND METHODS FOR SWIMMING POOLS AND SPAS

(71) Applicant: ZODIAC POOL SYSTEMS LLC, Carlsbad, CA (US)

(72) Inventors: Darin Eames, Carlsbad, CA (US); Dindo Uy, North Hollywood, CA (US); Mark J. Bauckman, San Marcos, CA (US); Robert Warren Stiles, JR., San Marcos, CA (US)

(73) Assignee: ZODIAC POOL SYSTEMS LLC, Carlsbad, CA (US)

(21) Appl. No.: 18/231,405

(22) Filed: Aug. 8, 2023

Related U.S. Application Data
(60) Provisional application No. 63/395,959, filed on Aug. 8, 2022.

(51) Int. Cl. G05B 13/02; E04H 4/12; E04H 4/14

(52) U.S. Cl. CPC G05B 13/026; E04H 4/12; E04H 4/148; G08B 5/36

(57) ABSTRACT

A method of operating a swimming pool or spa includes controlling equipment for a swimming pool or spa based on a predicted future state of the swimming pool or spa. A method of controlling equipment for a swimming pool or spa may include receiving a scheduled future use for the swimming pool or spa, predicting a future state of the swimming pool or spa based on the scheduled future use, and controlling the equipment to perform cleaning or other action based on the predicted future state. A method of operating a swimming pool or spa includes receiving an indication of a cleaning trigger event, generating a first alert based on the received indication, generating a cleaning response by equipment for the swimming pool or spa, and generating a second alert based on a state of the swimming pool or spa meeting or exceeding a threshold value.

### REFERENCE TO RELATED APPLICATION

This application claims the benefit of U.S. Provisional Patent Application No. 63/395,959, filed on Aug. 8, 2022, and entitled WATER QUALITY CONTROL SYSTEMS AND METHODS FOR SWIMMING POOLS AND SPAS, the content of which is hereby incorporated by reference in its entirety.

### FIELD OF THE INVENTION

The invention relates to systems and methods for water-containing vessels such as swimming pools and spas, and more particularly to systems and methods for controlling water quality of swimming pools and spas.

### BACKGROUND OF THE INVENTION

Various activities and/or events may affect water quality of a swimming pool or spa. As examples, occupant load, types of occupants within the pool, sanitary accidents within the pool, and/or weather events may affect water quality. Traditional approaches for controlling water quality are reactionary and/or require user input, thereby leaving periods of time when water quality may fall below desired standards.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a method includes controlling equipment for a swimming pool or spa based on a predicted future state of the swimming pool or spa.

According to some embodiments, a method includes using occupant information and/or environmental information to predict a future state of a swimming pool or spa.

According to various embodiments, a method of controlling equipment for a swimming pool or spa includes receiving a scheduled future use for the swimming pool or spa, predicting a future state of the swimming pool or spa based on the scheduled future use, and controlling the equipment to perform cleaning or other action based on the predicted future state.

According to various embodiments, a swimming pool or spa includes a pool control system for controlling a piece of equipment for the swimming pool or spa based on predicted future state.

According to certain embodiments, a method of operating a swimming pool or spa includes (i) receiving an indication of a cleaning trigger event, (ii) generating a first alert based on the received indication, (iii) generating a cleaning response by equipment for the swimming pool or spa, and (iv) generating a second alert based on a state of the swimming pool or spa meeting or exceeding a threshold value.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

### DESCRIPTION OF THE INVENTION

Described herein are control systems and methods for swimming pools or spas for controlling a pool to be in a desired state based on a future schedule or use. According to various embodiments, the systems and methods described herein may predict a future state of the swimming pool or spa, such as but not limited to water quality conditions, debris levels, temperature, etc. The future state of the swimming pool or spa may be predicted based on various types of information, such as but not limited to environmental information, user-supplied information, current pool conditions and/or equipment settings, sensed information including vision information from cameras or other vision systems, combinations thereof, and/or other information as desired. The systems and methods described herein may control one or more pieces of equipment based on the predicted future state of the swimming pool or spa. In some embodiments, the systems and methods described herein may predict a future state of the pool and schedule and control the swimming pool equipment to get to that state by the time of the future state. In certain embodiments, the systems and methods described herein may determine a plan or schedule for controlling equipment to reach a desired pool state at a desired point in the future based on external inputs such as user inputs and/or sensed information. Additionally, or alternatively, the systems described herein may provide improved cleaning responses based on a cleaning trigger event. Cleaning trigger events may include but are not limited to a child's accident in the pool, an improper chemical entering the pool, an animal entering a pool, and/or as otherwise desired. Various other benefits and advantages may be realized with the devices and methods provided herein, and the aforementioned advantages should not be considered limiting.

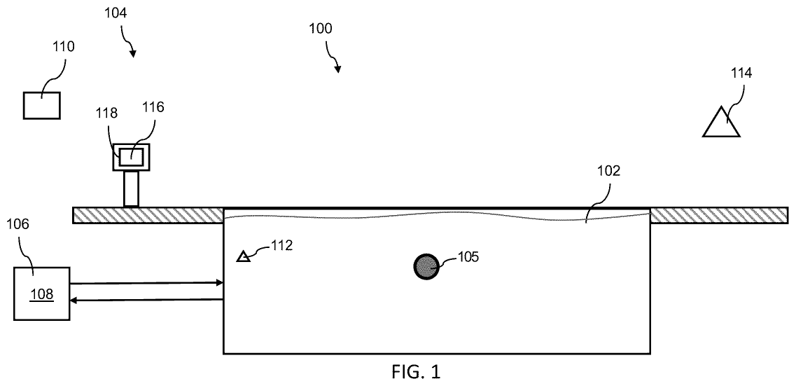

FIG. 1 illustrates an example of a pool system 100 including a swimming pool or spa (hereinafter “pool”) 102 and a control system 104. One or more pieces of equipment 106 may be associated with the pool 102, such as but not limited to a pump 108, an automatic or hydraulic swimming pool cleaner, a filtration system, a chemical dosing system, a heater or other temperature control system, a skimming system, a pool light 105, and/or other equipment or combinations of equipment as desired.

The control system 104 generally includes a controller 110. The controller 110 may include a computer system and/or one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data. The memory device may be local to the controller, portable, on a server, or in the cloud, among other locations.

The controller 110 may be provided at various locations, including both locations within or proximate to the pool 102 and/or locations remote from the pool 102. In certain embodiments, the controller 110 optionally includes an associated user interface, including but not limited to a graphical user interface or a human machine interface, such that the controller 110 may obtain information from a user and/or provide information to the user. Optionally, the control system 104 may include an interface 116 such as a speaker, screen, touchpad 118, lights, switches, combinations thereof, and/or other human machine interface as desired for receiving information from and/or providing information to a user. In such embodiments, the controller 110 may be communicatively coupled to the interface 116 using various wired or wireless techniques. The user interface and/or human machine interface may be on the controller 110 itself or may be at a location remote from the controller 110, such as on a user device, a dedicated user interface device, an operations control center remote from the pool system 100, combinations thereof, and/or as otherwise desired.

The controller 110 may be communicatively coupled with one or more pieces of equipment 106 using various wired or wireless communication techniques as desired such that the controller 110 may receive information from the equipment 106 and/or send control information to the equipment 106.

The controller 110 may receive various types of information from various sources as desired. In certain embodiments, the controller 110 may receive information about one or more characteristics or conditions of the pool 102, such as but not limited to water quality, temperature, debris levels, combinations thereof, and/or as otherwise desired. In some embodiments, the controller may receive information about current pool conditions or characteristics from the equipment 106 and/or one or more water sensors 112 (e.g., optical sensors, cameras, temperature sensors, pH sensors, turbidity sensors, combinations thereof, and/or other water sensors as desired). Additionally, or alternatively, the controller 110 may receive environmental information from one or more environmental sensors 114 and/or another external source. Environmental data may include, but is not limited to, wind data, humidity data, air temperature data, cloud coverage data, direct sunlight exposure data, season or time of year, occupancy data (e.g., presence of a user in the pool 102), combinations thereof, and/or other environmental data as desired. Non-limiting examples of environmental sensors 114 include but are not limited to wind gauges, humidity sensors, temperature sensors, cameras (e.g., for optical sensing), combinations thereof, other water sensors, and/or pool deck sensors. An external source of environmental data may include but is not limited to a weather forecast provider. In some embodiments, the controller 110 may receive performance or operation information for one or more pieces of equipment 106, including historical performance and current performance. As non-limiting examples, performance information may include a historical cycle time for a swimming pool cleaner, a heating efficiency of a heater, an operational state of a pump or heater (e.g., high, medium, low), combinations thereof, and/or other operation information as desired.

Additionally, or alternatively, the information may be received from a user of the pool 102 via an application on a user device and/or via the user interface 116. Such information from the user may include a number of occupants, a type of occupant (e.g., adult, child, pet, etc.), a duration of planned usage, a start time and day of the planned usage, etc. In such embodiments, the controller 110 may be communicatively coupled to an external device such as the user device (e.g., smartphone, laptop, etc.) using various wired or wireless communication techniques as desired such that the controller 110 may at least receive information from the external device. As a non-limiting example, the controller 110 may receive information from a user device via an application running on the user device. In certain embodiments, the controller 110 may be communicatively coupled to the user device such that the controller 110 provides notifications and/or alerts to the user, such as but not limited to a notification that the pool 102 is ready for the scheduled use and/or status or progress updates for various aspects of the pool and/or equipment 106 addressing such aspects.

In some embodiments, based on the received information, the controller 110 may predict a state of one or more characteristics of the pool 102 and thus anticipate needs for sanitization, filtration, cleaning, and other water quality or characteristic control. In certain embodiments, based on the predicted state, the controller 110 may generate a control response controlling one or more pieces of equipment 106. In various embodiments, the one or more pieces of equipment 106 may be controlled to provide a desired state of the one or more pool characteristics (e.g., at or above a threshold level) based on the predicted state.

A non-limiting example of such control by the control system 104 may include receiving from a user (e.g., via an application on a user device or via the interface 116) that twelve children will be using the pool 102 in twenty-four hours for a two hour pool party. The control system 104 may also obtain a weather forecast and current pool condition information (e.g., pH level, temperature, turbidity, etc.). Based on the information received from the user, weather forecast information, and/or current pool condition information, the controller 110 may predict a state of one or more characteristics of the pool (e.g., water quality, debris levels, filtration, temperature, etc.) for the pool 102 for the planned party (and thus anticipate needs for sanitization, filtration, cleaning, heating, etc.). In various embodiments, based on the predicted state of the one or more characteristics, the controller 110 may control one or more pieces of equipment 106 to achieve or exceed a threshold value for the one or more characteristics within a predetermined period of time and/or at the time of the future scheduled use.

As another non-limiting example, the control system 104 may receive an indication from a user that a party or other heavy-usage even is scheduled in two weeks. Based on the future scheduled use, the control system 104 may generate a schedule for controlling of one or more pieces of equipment 106 such that the water quality is good (e.g., at or above a water quality threshold), the pool 102 is clean (e.g., at or above a debris level threshold), and the temperature is at a set temperature (e.g., 80 degrees). In some cases, the control system 104 may further include environmental data such as a forecast thunderstorm the day before the event. In this example, whereas the control system 104 may have scheduled the heater to start heating three days in advance in a normal operating mode, the control system 104 may account for the thunderstorm and schedule to heat the pool 102 more than usual (e.g., at a higher temperature and/or longer duration) to reach the desired temperature at the time of the future scheduled use.

Additionally, or alternatively, to predicting water quality, the control systems 104 described herein may provide improved cleaning responses responsive to a cleaning trigger event. Cleaning trigger events may include but are not limited to a hygienic or sanitary event such as an accident (e.g., from a child) in the pool, an improper chemical entering the pool, an animal entering a pool, and/or as otherwise desired. The cleaning trigger event may be detected by the control system 104 (e.g., based on information from equipment 106 and/or sensors 112) and/or the cleaning trigger event may be provided by the user to the control system 104. As a non-limiting example, a user may use the interface 116 to indicate that a child has had an accident in the pool 102.

In certain embodiments, based on the receipt or determination of the cleaning trigger event, the control system 104 may determine a cleaning response for equipment 106 of the pool 102 and control the equipment 106 pursuant to the determined cleaning response. As a non-limiting example, the control system 104 may determine that the cleaning response includes controlling equipment 106 such that the pool 102 is super chlorinated to 20 ppm, a secondary sanitizer system maximizes ozone production, and a filter is adjusted to its smallest sub-micron diameters.

Optionally, based on the receipt or determination of the cleaning trigger event, the control system 104 may generate an alert. In some embodiments, generating the alert may include using the interface 116 to provide the alert. In various embodiments, generating the alert may include sending an alert to a user device (e.g., using an application). As a non-limiting example, an application on the user device may provide real time status updates of water quality and/or state of the pool 102, and the application may notify the user when it is safe to re-enter the pool 102.

Additionally, or alternatively, one or more pieces of equipment 106 may be controlled to provide the alert. As a non-limiting example, the control system 104 may cause pool lights 105 to have a first characteristic (e.g., color, brightness, pattern, etc.), such as but not limited to turn red and operate in a flashing pattern. Additionally, or alternatively, the control system 104 may cause an audible alert to be generated on the interface 116 and/or a speaker. In some embodiments, the alert may be provided by the control system 104 for the duration of the cleaning response (e.g., until water quality and condition is at a threshold level), although it need not in other embodiments. Optionally, based on the completion of the cleaning response and the water quality being at a threshold level, the control system 104 may generate a clear alert indicating that the water is safe to enter. As a non-limiting example, the control system 104 may change one or more characteristics of the pool lights 105, such as but not limited to changing the lights 105 from a flashing red pattern to a solid green pattern upon the completion of the cleaning response and/or the water quality being at the threshold level.

The aforementioned examples of water quality control are for illustrative purposes only and should not be considered limiting, and in other embodiments, other types of water quality control may be utilized as desired.

Exemplary concepts or combinations of features of the invention may include:
A. A method comprising controlling equipment for a swimming pool or spa based on a predicted future state of the swimming pool or spa.
B. The method according to any preceding or subsequent statement or combination of statements, further comprising receiving future occupant information and predicting the future state of the swimming pool or spa based on the received future occupant information.
C. The method according to any preceding or subsequent statement or combination of statements, further comprising receiving environmental information and predicting the future state of a swimming pool or spa based on the received environmental information.
D. The method according to any preceding or subsequent statement or combination of statements, wherein the predicted future state of the swimming pool spa comprises a predicted future state for at least one of a water quality of the swimming pool or spa, a debris level of the swimming pool or spa, or a temperature of the swimming pool or spa.
E. The method according to any preceding or subsequent statement or combination of statements, wherein the predicted future state is at a set time, and wherein controlling the equipment comprises comparing the predicted future state to a desired state at the set time and scheduling control of the equipment for the swimming pool or spa based on a difference between the predicted future state and the desired state at the set time.
F. The method according to any preceding or subsequent statement or combination of statements, wherein the equipment for the swimming pool or spa comprises at least one of a pump, an automatic swimming pool cleaner, a hydraulic swimming pool cleaner, a filtration system, a chemical dosing system, a heater, or a skimming system.
G. The method according to any preceding or subsequent statement or combination of statements, further comprising: predicting the future state based on a scheduled future use of the swimming pool or spa; receiving environmental data; receiving data about at least one characteristic of the swimming pool or spa; and generating a schedule for controlling the equipment based on the predicted future state, the environmental data, and the data about at least one characteristic of the swimming pool or spa.
H. A method comprising using occupant information and/or environmental information to predict a future state of a swimming pool or spa.
I. The method according to any preceding or subsequent statement or combination of statements, further comprising controlling equipment for the swimming pool or spa based on the predicted future state.
J. A method of controlling equipment for a swimming pool or spa, the method comprising receiving a scheduled future use for the swimming pool or spa, predicting a future state of the swimming pool or spa based on the scheduled future use, and controlling the equipment to perform cleaning or other action based on the predicted future state.
K. The method according to any preceding or subsequent statement or combination of statements, wherein receiving the scheduled future use comprises receiving at least one of a number of occupants, a type of occupant, a duration of planned usage, or a start time and day of the planned usage.
L. The method of to any preceding or subsequent statement or combination of statements, wherein controlling the equipment comprises generating a schedule for controlling the equipment such that at least one characteristic of the swimming pool or spa is at a desired state by a start of the scheduled future use.
M. The method according to any preceding or subsequent statement or combination of statements, further comprising receiving environmental data, and wherein predicting the future state of the swimming pool or spa is based on the scheduled future use and the environmental data.
N. The method according to any preceding or subsequent statement or combination of statements, further comprising receiving data about at least one characteristic of the swimming pool or spa, and wherein predicting the future state of the swimming pool or spa is based on the scheduled future use and the data about at least one characteristic of the swimming pool or spa.
O. The method according to any preceding or subsequent statement or combination of statements, wherein the predicted future state of the swimming pool spa comprises a predicted future state for at least one of a water quality of the swimming pool or spa, a debris level of the swimming pool or spa, or a temperature of the swimming pool or spa.
P. A swimming pool or spa comprising a pool control system for controlling a piece of equipment for the swimming pool or spa based on predicted future state.
Q. A method of operating a swimming pool or spa, the method comprising (i) receiving an indication of a cleaning trigger event, (ii) generating a first alert based on the received indication, (iii) generating a cleaning response by equipment for the swimming pool or spa, and (iv) generating a second alert based on a state of the swimming pool or spa meeting or exceeding a threshold value.
R. The method according to any preceding or subsequent statement or combination of statements, wherein generating the first alert comprises controlling at least one pool light to have a first state of a characteristic and wherein generating the second alert comprises controlling the at least one pool light to have a second state of the characteristic different from the first characteristic.
S. The method according to any preceding or subsequent statement or combination of statements, wherein the characteristic comprises a color of the at least one pool light, a brightness of the at least one pool light, or a flashing pattern of the at least one pool light.
T. The method according to any preceding or subsequent statement or combination of statements wherein the cleaning trigger event is received on an application.
U. The method according to any preceding or subsequent statement or combination of statements, wherein the cleaning trigger event comprises at least one of a hygienic or sanitary event in the pool, an improper chemical entering the pool, or an animal entering a pool.
V. A swimming pool or spa comprising a pool control system for controlling a piece of equipment pursuant to the method according to any preceding or subsequent statement or combination of statements.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Finally, references to “pools” and “swimming pools” herein may also refer to spas or other water containing vessels used for recreation, training, or therapy and for which cleaning of debris is needed or desired.

That which is claimed:

1. A method of operating a swimming pool or spa comprising controlling equipment for the swimming pool or spa based on a predicted future state of the swimming pool or spa.

2. The method of claim 1, further comprising receiving future occupant information and predicting the future state of the swimming pool or spa based on the received future occupant information.

3. The method of claim 1, further comprising receiving environmental information and predicting the future state of a swimming pool or spa based on the received environmental information.

4. The method of claim 1, wherein the predicted future state of the swimming pool spa comprises a predicted future state for at least one of a water quality of the swimming pool or spa, a debris level of the swimming pool or spa, or a temperature of the swimming pool or spa.

5. The method of claim 1, wherein the predicted future state is at a set time, and wherein controlling the equipment comprises comparing the predicted future state to a desired state at the set time and scheduling control of the equipment for the swimming pool or spa based on a difference between the predicted future state and the desired state at the set time.

6. The method of claim 1, wherein the equipment for the swimming pool or spa comprises at least one of a pump, an automatic swimming pool cleaner, a hydraulic swimming pool cleaner, a filtration system, a chemical dosing system, a heater, or a skimming system.

7. The method of claim 1, further comprising:
predicting the future state based on a scheduled future use of the swimming pool or spa;
receiving environmental data;
receiving data about at least one characteristic of the swimming pool or spa; and
generating a schedule for controlling the equipment based on the predicted future state, the environmental data, and the data about at least one characteristic of the swimming pool or spa.

8. A swimming pool or spa comprising a pool control system for controlling a piece of equipment pursuant to the method of claim 1.

9. A method of controlling equipment for a swimming pool or spa, the method comprising:
receiving a scheduled future use for the swimming pool or spa;
predicting a future state of the swimming pool or spa based on the scheduled future use; and
controlling the equipment to perform cleaning or other action based on the predicted future state.

10. The method of claim 9, wherein receiving the scheduled future use comprises receiving at least one of a number of occupants, a type of occupant, a duration of planned usage, or a start time and day of the planned usage.

11. The method of claim 9, wherein controlling the equipment comprises generating a schedule for controlling the equipment such that at least one characteristic of the swimming pool or spa is at a desired state by a start of the scheduled future use.

12. The method of claim 9, further comprising receiving environmental data, and wherein predicting the future state of the swimming pool or spa is based on the scheduled future use and the environmental data.

13. The method of claim 9, further comprising receiving data about at least one characteristic of the swimming pool or spa, and wherein predicting the future state of the swimming pool or spa is based on the scheduled future use and the data about at least one characteristic of the swimming pool or spa.

14. The method of claim 9, wherein the predicted future state of the swimming pool spa comprises a predicted future state for at least one of a water quality of the swimming pool or spa, a debris level of the swimming pool or spa, or a temperature of the swimming pool or spa.

15. A swimming pool or spa comprising a pool control system for controlling a piece of equipment pursuant to the method of claim 9.

16. A method of operating a swimming pool or spa, the method comprising (i) receiving an indication of a cleaning trigger event, (ii) generating a first alert based on the received indication, (iii) generating a cleaning response by equipment for the swimming pool or spa, and (iv) generating a second alert based on a state of the swimming pool or spa meeting or exceeding a threshold value.

17. The method of claim 16, wherein generating the first alert comprises controlling at least one pool light to have a first state of a characteristic and wherein generating the second alert comprises controlling the at least one pool light to have a second state of the characteristic different from the first characteristic.

18. The method of claim 17, wherein the characteristic comprises a color of the at least one pool light, a brightness of the at least one pool light, or a flashing pattern of the at least one pool light.

19. The method of claim 16 wherein the cleaning trigger event is received on an application.

20. The method of claim 16, wherein the cleaning trigger event comprises at least one of a hygienic or sanitary event in the pool, an improper chemical entering the pool, or an animal entering a pool.
